(19) United States
(12) Patent Application Publication
(10) Pub. No.: US 2005/0089097 A1
(43) Pub. Date: Apr. 28, 2005

(54) Memory management method for storing motion vectors of decoded macroblocks

(76) Inventors: Hui-Hua Kuo, Tai-Nan City (TW); Gong-Sheng Lin, Tai-Chung City (TW)

Correspondence Address: NORTH AMERICA INTERNATIONAL PATENT OFFICE (NAIPC), P.O. BOX 506, MERRIFIELD, VA, 22116, US

(21) Appl. No.: 10/710,722

(22) Filed: Jul. 30, 2004

(30) Foreign Application Priority Data
Jul. 30, 2003 (TW) 092120908

(51) Int. Cl. H04N 7/12

(52) U.S. Cl. 375/240.16; 375/240.24; 375/240.12

(57) ABSTRACT

A method for using memory to store motion vectors of decoded macroblocks as candidate predictors used in future motion vector decoding process. For a decoded first macroblock, the method allocates a first memory space and a second memory space in a first memory, and allocates a third memory space and a fourth memory space in a second memory for storing the motion vector(s) of the first macroblock. When allocating memory spaces in the first memory, the method considers a row of macroblocks in the video frame as a whole, and allocates a plurality of memory units that are sufficient for storing motion vectors of a row of macroblocks. During the process of decoding each row of macroblocks, the memory units of the first memory can be re-used to store motion vectors of decoded macroblocks.

### BACKGROUND OF INVENTION

1. Field of the Invention

The present invention provides a memory management method for storing motion vector(s) of decoded macroblocks, and more particularly, to a memory management method for storing motion vector(s) of decoded macroblocks for providing candidate predictors in future decoding processes.

2. Description of the Prior Art

The motion picture experts group (MPEG) was established in 1988 and is a working group of the international organization for standardization (ISO). This working group has set up several audio/video compression formats of different versions. MPEG-1 and MPEG-2 are two video compression standards widely used today, and these two video compression standards have some common points. When processing video encoding/decoding with the MPEG standards, a 16*16 pixel macroblock (MB) is the basic unit for dealing with motion vectors (MV). In the MPEG standards, a macroblock can have a single motion vector for the whole macroblock, and in such situation the macroblock is called a “large region”. Or, a macroblock can be composed of four 8*8 blocks with each block having its own motion vector. In such situation, each 8*8 block is called a “small region”. Additionally, a macroblock can be composed of two fields, each field having its own motion vector. In this situation, each field is called a “field region”.

A video frame (in MPEG-4 standard a video frame is also called a VOP, which stands for video object plane) can be a progressive frame or an interlaced frame. A progressive frame may be irregularly composed of the above-mentioned large regions and small regions. FIG. 1 shows an example of a progressive frame. An interlaced frame is irregularly composed of the above-mentioned large regions, small regions and field regions. FIG. 2 shows an example of an interlaced frame. Note that in FIG. 1 and FIG. 2, 110 is a large region, 115 is the motion vector of the large region, 130 is a small region, 135 is the motion vector of the small region, 150 is a field region, and 155 is the motion vector of the field region.

When processing motion compensation (MC), motion vectors must be decoded. Taking MPEG-4 standard as an example, P-VOP (which stands for predicted VOP) and S(GMC)-VOP (which stands for sprite global motion compensation VOP) are two kinds of video object planes that are encoded through using motion vectors. For decoding a motion vector of this kind of video object planes, the horizontal and vertical motion vector components are decoded differentially using a prediction. The prediction is formed by a median filtering of three vector candidate predictors from spatial neighborhood macroblocks or blocks already decoded. In the following description, when a macroblock contains only one motion vector for the whole macroblock, it will be referred to as a type-1 macroblock; when a macroblock contains four blocks (a first block in the top-left corner, a second block in the top-right corner, a third block in the bottom-left corner, and a fourth block in the bottom-right corner) and four corresponding motion vectors, it will be referred to as a type-2 macroblock; and when a macroblock contains two fields (a first field and a second field) and two corresponding motion vectors, it will be referred to as a type-3 macroblock.

When the video frame being decoded is a progressive frame, it is possible that the decoding macroblock and the spatial neighborhood macroblocks for providing candidate predictors are all type-1 macroblocks. This situation is shown in FIG. 3, where macroblocks A, B, C, X are all type-1 macroblocks. When decoding the motion vector of macroblock X, the motion vectors of the spatial neighborhood macroblocks A, B, and C are used as candidate predictors to determine the motion vector predictor of macroblock X. The predictor for the horizontal component (Px) and vertical component (Py) are computed by:
Px=Median (MV1x,MV2x,MV3x)
Py=Median (MV1y,MV2y,MV3y)
where Median is a function for determining a median. For example, when MV1=(−2,3), MV2=(1,5), MV3=(−1,7), Px and Py are −1 and 5, respectively.

When the video frame being decoded is a progressive frame, it is also possible that the decoding macroblock and the spatial neighborhood macroblocks for providing candidate predictors are all type-2 macroblocks. These situations are shown in FIG. 4, FIG. 5, FIG. 6, and FIG. 7. Please first refer to FIG. 4. When decoding the motion vector of macroblock X's first block, the motion vector of macroblock A's second block, the motion vector of macroblock B's third block, and the motion vector of macroblock C's third block are used as candidate predictors. Please refer to FIG. 5. When decoding the motion vector of macroblock X's second block, the motion vector of macroblock X's first block (already decoded), the motion vector of macroblock B's fourth block, and the motion vector of macroblock C's third block are used as candidate predictors. Please next refer to FIG. 6. When decoding the motion vector of macroblock X's third block, the motion vector of macroblock A's fourth block, the motion vectors of macroblock X's first and second blocks (already decoded) are used as candidate predictors. Please next refer to FIG. 7. When decoding the motion vector of macroblock X's fourth block, the motion vectors of macroblock X's first, second, and third blocks (already decoded) are used as candidate predictors. The method of calculation is the same as previously mentioned, specifically:
Px=Median (MV1x,MV2x,MV3x);
Py=Median (MV1y,MV2y,MV3y).

When the video frame being decoded is an interlaced frame, it is possible that the decoding macroblock or the spatial neighborhood macroblocks for providing candidate predictors are type-3 macroblocks. These situations are as shown in FIG. 8, FIG. 9, and FIG. 10. Please first refer to FIG. 8. The decoding macroblock X is a type-3 macroblock, while macroblocks A, B, C are type-2 macroblocks. When decoding the motion vectors of macroblock X's first field and second field, the motion vector of macroblock A's second block, the motion vector of macroblock B's third block, and the motion vector of macroblock C's third block are used as candidate predictors. Please next refer to FIG. 9. One or more macroblock(s) of A, B, C (in this example, macroblock B) is a type-3 macroblock, and has two motion vectors MV2f1 and MV2f2. In this situation the candidate predictors MV2x and MV2y provided by macroblock B are computed as follows:
MV2x=Div2Round (MV2x_{—}f1,MV2x_{—}f2)
MV2y=Div2Round (MV2y_{—}f1,MV2y_{—}f2)
where Div2Round is an average then carry function. For example, when MV2x_f1=(1,2), MV2x_f2=(4,5), MV2x and MV2y are 3 and 4 respectively. After MV2 is calculated, Px and Py can be determined through the above-mentioned Median function. Please refer to FIG. 10. Macroblocks A, B, C, and X are all type-3 macroblocks. In this situation the candidate predictors MV1, MV2, and MV3 provided by macroblock A, B, and C are all determined through the above-mentioned Div2Round function, specifically:
MVix=Div2Round (MVix_{—}f1,MVix_{—}f2)
MViy=Div2Round (MViy_{—}f1,MViy_{—}f2), where i={1, 2, 3}

The motion vector predictor Px and Py for both the first and second field of macroblock X can then be determined through the above-mentioned Median function.

Please refer to FIG. 11 showing a conventional system for processing motion compensation. The system shown in FIG. 11 is an integrated system for processing progressive frames and interlaced frames. The variable length decoder (VLD) 210 is for computing a differential motion vector Diff. The multiplexer 250 is for determining how to provide candidate predictors according to VOP-Type (i.e. whether the video frame is a progressive frame or an interlaced frame). Multiplexers 251, 254 are for selecting a candidate predictor provided by macroblock A according to MB_A_Type. Multiplexers 252, 255 are for selecting a candidate predictor provided by macroblock B according to MB_B_Type. Multiplexers 253, 256 are for selecting a candidate predictor provided by macroblock C according to MB_C_Type. Prediction filters 220 and 221 are for determining a motion vector predictor (Predictor) by median filtering of the candidate predictors. Filters 261, 262, 263 are responsible for the Div2Round function. Motion vector calculator (MV_CAL) 230 is then used for determining prediction differences between video frames according to Diff and Predictor. Finally, the motion compensator (MC) 240 can perform motion compensation according to the result computed by the motion vector calculator 230.

Because before designing the system, it is not certain which type macroblocks A, B, C will be, while allocating memory space, three different situations of three spatial neighborhood macroblocks should be considered. This means, for each macroblock A, B, and C, the system should allocate a memory space being sufficient for storing a single motion vector of a macroblock (for dealing with the situation when the macroblock is a type-1 macroblock), four memory spaces each being sufficient for storing a motion vector of a block (for dealing with the situation when the macroblock is a type-2 macroblock), and two memory spaces each being sufficient for storing a motion vector of a field (for dealing with the situation when the macroblock is a type-3 macroblock). In other words, for each macroblock to provide a candidate predictor, the system should allocate seven memory spaces each being sufficient for storing a motion vector.

The conventional memory allocating method consumes a lot of memory space. When decoding motion vectors, systems of the prior art consider each video frame as a whole. In other words, taking a frame with 720*480 pixels as an example, when storing motion vector(s) of each decoded macroblock (which will become macroblock B and C for future decoding of macroblock X), the system must allocate (720/16)*(480/16)*7 memory spaces in a first memory. When storing motion vector(s) of each decoded macroblock (which will become macroblock A for future decoding of macroblock X), the system must allocate seven memory spaces in a second memory. This method is costly and is not ideal for system implementation.

### SUMMARY OF INVENTION

It is therefore an object of the invention to provide a memory management method for storing motion vector(s) of decoded macroblocks to solve the above-mentioned problem.

According to the embodiment, a memory management method used in the decoding process of a video frame is disclosed. The method is for storing motion vector(s) of a decoded first macroblock as candidate predictor(s) for future use in the decoding process, and includes the following steps: allocating a first memory space and a second memory space in a first memory, wherein each of the first and the second memory spaces is sufficient for storing one motion vector; and when the first macroblock has only one first motion vector, storing the first motion vector in the first or the second memory space.

The embodiment also discloses a memory management method used in the decoding process of a video frame. The method is for storing the motion vector(s) of a decoded first macroblock as candidate predictor(s) for use in decoding a next macroblock. The method includes: allocating a third memory space and a fourth memory space in a second memory, wherein each of the third and the fourth memory spaces is sufficient for storing one motion vector; and when the first macroblock has only one first motion vector, storing the first motion vector in the third or the fourth memory space.

Additionally, the embodiment also suggest a memory reuse implementation method. That is, when allocating memory space in the first memory, the embodiment considers each row of macroblocks as a whole. A plurality of memory units sufficient for storing motion vectors of a row of macroblocks are allocated, and are reused each time a new row is decoded. In this way, the embodiment greatly saves memory resources comparing to the prior art.

These and other objectives of the present invention will no doubt become obvious to those of ordinary skill in the art after reading the following detailed description of the preferred embodiment that is illustrated in the various figures and drawings.

### BRIEF DESCRIPTION OF DRAWINGS

FIG. 1 is an example of a progressive frame.

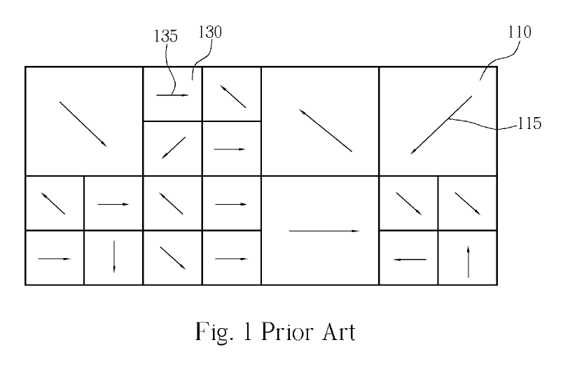

FIG. 2 is an example of an interlaced frame.

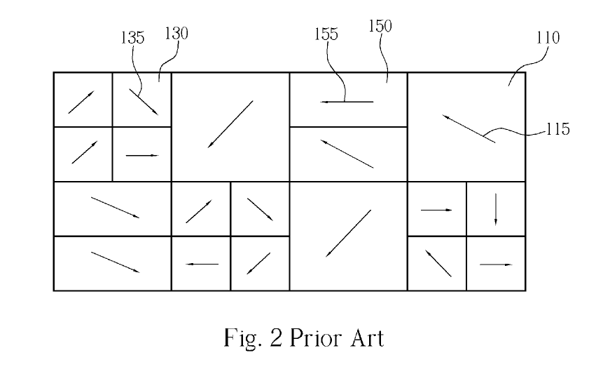

FIG. 3 shows a situation when macroblocks A, B, C, and X are all type-1 macroblocks.

FIG. 4 shows a first situation when macroblocks A, B, C, and X are all type-2 macroblocks.

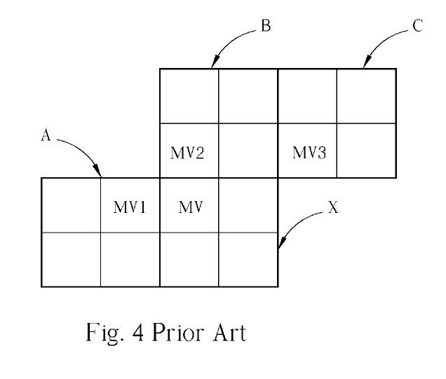

FIG. 5 shows a second situation when macroblocks A, B, C, and X are all type-2 macroblocks.

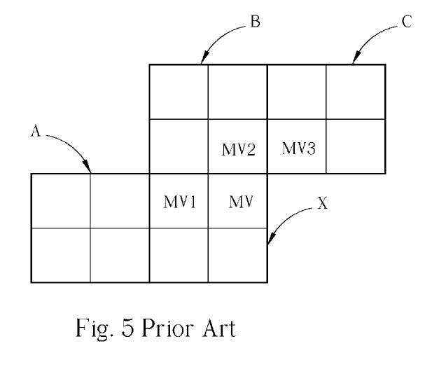

FIG. 6 shows a third situation when macroblocks A, B, C, and X are all type-2 macroblocks.

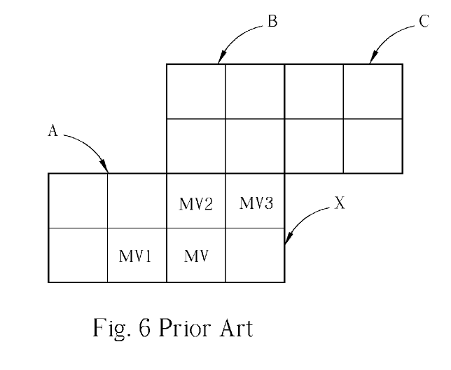

FIG. 7 shows a fourth situation when macroblocks A, B, C, and X are all type-2 macroblocks.

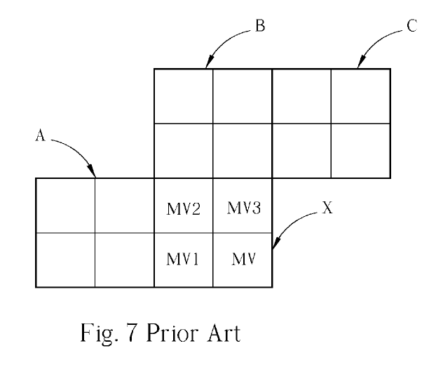

FIG. 8 shows a first situation when macroblocks A, B, C, and X comprise at least one type-3 macroblock.

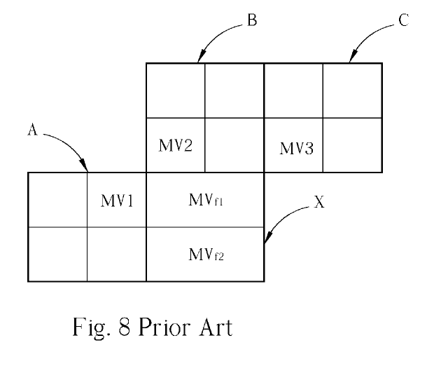

FIG. 9 shows a second situation when macroblocks A, B, C, and X comprise at least one type-3 macroblock.

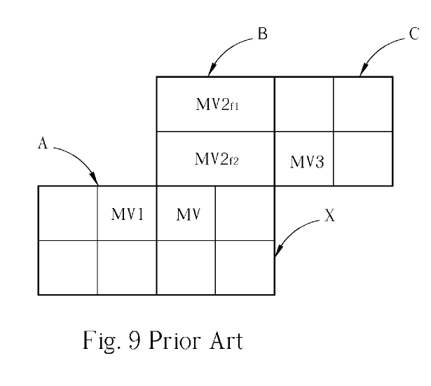

FIG. 10 shows a situation when macroblocks A, B, C, and X are all type-3 macroblocks.

FIG. 11 is a conventional system for processing motion compensation.

FIG. 12 is a first flowchart according to a first embodiment of the present invention.

FIG. 13 is a second flowchart according to a second embodiment of the present invention.

FIG. 14 is a third flowchart according to a third embodiment of the present invention.

FIG. 15 is a system for processing motion compensation with the method provided by the present invention.

### DETAILED DESCRIPTION

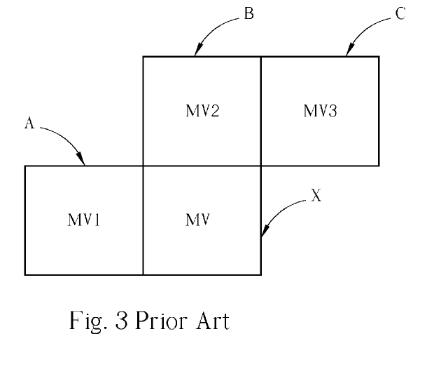

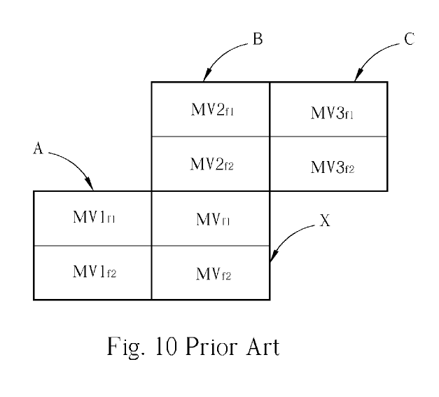

Referring to FIG. 3˜FIG. 10, when decoding the motion vector(s) of a macroblock X, two already decoded macroblocks on a previous row (that is the row directly above macroblock X) will be used as a macroblock B and a macroblock C to provide candidate predictors. In other words, for each decoded macroblock, when a macroblock on a next row (that is the row directly beneath the decoded macroblock) is going to be decoded, it is possible that the decoded macroblock will be used as a macroblock B or a macroblock C to provide candidate predictor(s). Hence, each time when a macroblock is decoded, its motion vector(s) should be stored, in case the motion vector(s) will be used as candidate predictor(s) in future decoding process (when decoding macroblocks on the next row). To deal with ssuch situation through the conventional method, seven memory spaces each being sufficient for storing one motion vector are allocated for each decoded macroblock (note that before designing the system, it is not certain which type a decoded macroblock will be). However, in actuality, if the decoded macroblock is a type-1 macroblock, saving only one motion vector of the whole macroblock will be enough (because a type-1 macroblock has only motion vector). If the decoded macroblock is a type-2 macroblock, saving two motion vectors of the macroblock (specifically, the motion vectors of the third and fourth blocks) will be enough, because only these two motion vectors are possible to be used as candidate predictors when decoding macroblocks on the next row. If the decoded macroblock is a type-3 macroblock, saving two motion vectors (the motion vectors of the first and second fields) of the macroblock will be enough, because the candidate predictor used in decoding macroblocks on the next row can be determined through applying Div2Round function on the two stored motion vectors. In conclusion, to deal with this situation, no matter what type the decoded macroblock belongs to, allocating two memory spaces (each being sufficient for storing one motion vector) for each decoded macroblock is enough.

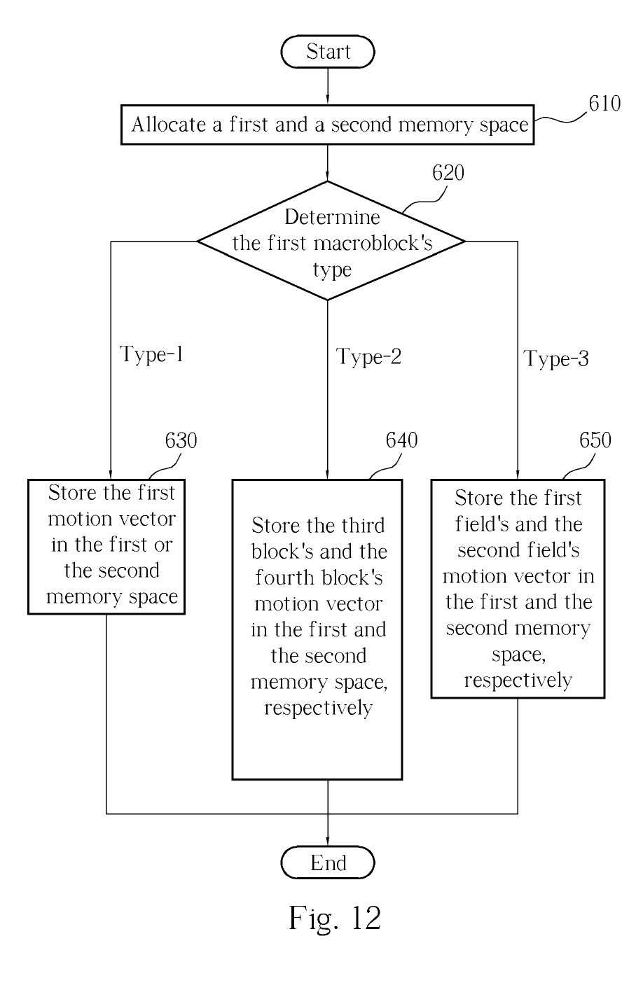

FIG. 12 shows a flowchart according to a first embodiment of the present invention. The flowchart shown in FIG. 12 includes the following steps:
610: Allocate a first memory space and a second memory space in a first memory for a decoded first macroblock regardless of whether the first macroblock is a type-1, type-2, or type-3 macroblock. Each of the first memory space and the second memory space is sufficient for storing a motion vector.
620: Determine the type of the first macroblock. When the first macroblock is a type-1 macroblock, go to step 630; when the first macroblock is a type-2 macroblock, go to step 640; and when the first macroblock is type-3 macroblock, go to step 650.
630: The first macroblock is a type-1 macroblock having a first motion vector. Store the first motion vector in the first or the second memory spaces. Although one memory space is enough for storing the first motion vector under this situation, it is also practicable to store the first motion vector in both the first and the second memory spaces.
640: The first macroblock is a type-2 macroblock having four blocks. Store the motion vector of the first macroblock's third block in the first memory space, and store the motion vector of the first macroblock's fourth block in the second memory space.
650: The first macroblock is a type-3 macroblock having a first field and a second field. Store the motion vector of the first macroblock's first field in the first memory space, and store the motion vector of the first macroblock's second field in the second memory space.

Specifically, this flowchart shows an embodiment of the present invention explaining how to allocate memory spaces and how to use the allocated memory spaces to store the motion vector(s) of the decoded first macroblock, considering the possibility that the motion vector(s) of the first macroblock will be used as candidate predictor(s) when macroblocks on the next row is going to be decoded.

By using the flowchart shown in FIG. 12, no matter what type the decoded first macroblock belongs to, when decodeing macroblocks on the next row, candidate predictor(s) can be determined according to the motion vectors stored in the first and second memory spaces. More specifically, when the first macroblock is a type-1 macroblock, the candidate predictor provided by the first macroblock could be the one stored in the first or the second memory space (these two motion vectors are the same). When the first macroblock is a type-2 macroblock, the candidate predictor provided by the first macroblock could be the one stored in the first memory space (if the motion vector of the third block is used as the candidate predictor), or the one stored in the second memory space (if the motion vector of the fourth block is used as the candidate predictor). When the first macroblock is a type-3 macroblock, the candidate predictor provided by the first macroblock could be determined though applying Div2Round function on the two motion vectors stored in the first and second memory spaces.

Please note that the first memory can be implemented by a dynamic random access memory (DRAM), a static random access memory (SRAM), registers, or other devices capable of storing data.

Furthermore, referring to FIG. 3˜FIG. 10, when decoding the motion vector(s) of macroblock X, an already decoded macroblock on the left of macroblock X will be used as a macroblock A to provide candidate predictor(s). In other words, for each decoded macroblock, when a next macroblock (that is the macroblock on the right of the decoded macroblock) is going to be decoded, the decoded macroblock will be used as a macroblock A to provide candidate predictor(s). Hence, each time when a macroblock is decoded, its motion vector(s) will be stored, in case the motion vector(s) will be used as candidate predictor(s) in decoding a next macroblock. To deal with this situation using the conventional method, seven memory spaces each being sufficient for storing one motion vector must be allocated for each decoded macroblock (note that when designing the system, it is not certain which type a decoded macroblock will be). However, in actuality, if the decoded macroblock is a type-1 macroblock, saving only one motion vector of the whole macroblock will be enough (because a type-1 macroblock has only motion vector). If the decoded macroblock is a type-2 macroblock, saving two motion vectors (the motion vectors of the second and fourth blocks) of the macroblock will be enough, because only these two motion vectors are possible to be used as candidate predictors when decoding a next macroblock. If the decoded macroblock is a type-3 macroblock, saving two motion vectors (the motion vectors of the first and second fields) of the macroblock will be enough, because the candidate predictor used in decoding the next macroblocks can be determined through applying Div2Round function on the two stored motion vectors. In conclusion, to deal with this situation, no matter what type the decoded macroblock belongs to, allocating two memory spaces (each being sufficient for storing one motion vector) for each decoded macroblock is enough.

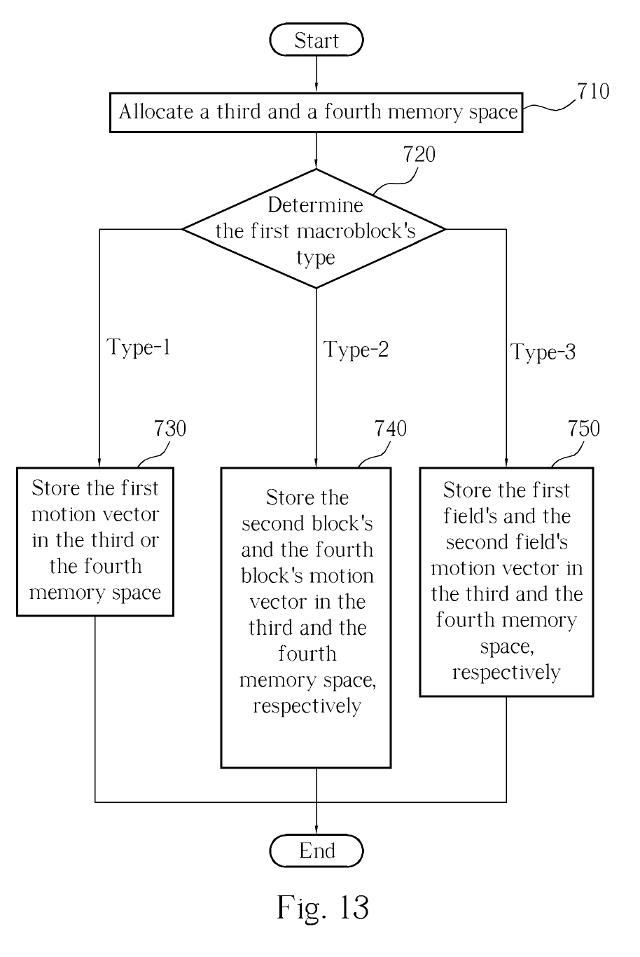

FIG. 13 shows a flowchart according to a second embodiment of the present invention. The flowchart shown in FIG. 13 contains the following steps:
710: Allocate a third memory space and a fourth memory space in a second memory for a decoded first macroblock regardless of whether the first macroblock is a type-1, type-2, or type-3 macroblock. Each of the third memory space and the fourth memory space is sufficient for storing a motion vector.
720: Determine the type of the first macroblock. When the first macroblock is a type-1 macroblock, go to step 730; when the first macroblock is a type-2 macroblock, go to step 740; when the first macroblock is type-3 macroblock, go to step 750.
730: The first macroblock is a type-1 macroblock having a first motion vector. Store the first motion vector in the third or the fourth memory space. Although one memory space is enough for storing the first motion vector under this situation, it is also practicable to store the first motion vector in both the third and the fourth memory spaces.
740: The first macroblock is a type-2 macroblock having four blocks. Store the motion vector of the first macroblocks second block in the third memory space, and store the motion vector of the first macroblocks fourth block in the fourth memory space.
750: The first macroblock is a type-3 macroblock having a first field and a second field. Store the motion vector of the first macroblock's first field in the third memory space, and store the motion vector of the first macroblock's second field in the fourth memory space.

Specifically, this flowchart shows an embodiment of the present invention explaining how to allocate memory spaces and how to use the allocated memory spaces to store the motion vector(s) of the decoded first macroblock, considering that the motion vector(s) of the first macroblock will be used as candidate predictor(s) when a next macroblocks is going to be decoded.

By using the flowchart shown in FIG. 13, no matter what type the decoded first macroblock belongs to, when decoding a next macroblock, candidate predictor(s) can be determined according to the motion vectors stored in the third and fourth memory spaces. More specifically, when the first macroblock is a type-1 macroblock, the candidate predictor provided by the first macroblock could be the one stored in the third or the fourth memory space (these two motion vectors are the same). When the first macroblock is a type-2 macroblock, the candidate predictor provided by the first macroblock could be the one stored in the third memory space (if the motion vector of the second block is used as the candidate predictor), or the one stored in the fourth memory space (if the motion vector of the fourth block is used as the candidate predictor). When the first macroblock is a type-3 macroblock, the candidate predictor provided by the first macroblock could be determined though applying Div2Round function on the two motion vectors stored in the third and fourth memory spaces.

Please note that the second memory can be implemented by a dynamic random access memory (DRAM), a static random access memory (SRAM), registers, or other devices capable of storing data. Additionally, the first memory and the second memory can be realized as two separate memory devices or a single memory device, as can be appreciated by people familiar with the related arts.

Aside from macroblocks located on the last row and the last column of each video frame (or VOP), every decoded macroblock will have to provide its motion vector(s) as candidate predictor(s) for decoding a next macroblock and for decoding macroblocks on a next row. Hence, for each of these macroblocks, both the flowchart shown in FIG. 12 and FIG. 13 could be used to allocate memory spaces to store its motion vector(s). For those decoded macroblocks located on the last row of each frame (except for the last macroblock of the whole video frame), their motion vector(s) will not be used as candidate predictor(s) when macroblocks on a next row are going to be decoded (because the last row does not have a “next row” in the video frame). Hence using only the flowchart shown in FIG. 13 would be enough. For those decoded macroblocks located on last column of each frame (except for the last macroblock of the whole video frame), their motion vectors will not be used as candidate predictor(s) when a next macroblocks on the same row is going to be decoded (because there is no “next macroblock” located on the same row). Hence using only the flowchart shown in FIG. 12 would be enough. For the last macroblock of the whole video frame, its motion vectors will not be used as candidate predictor(s) and therefore need not be stored.

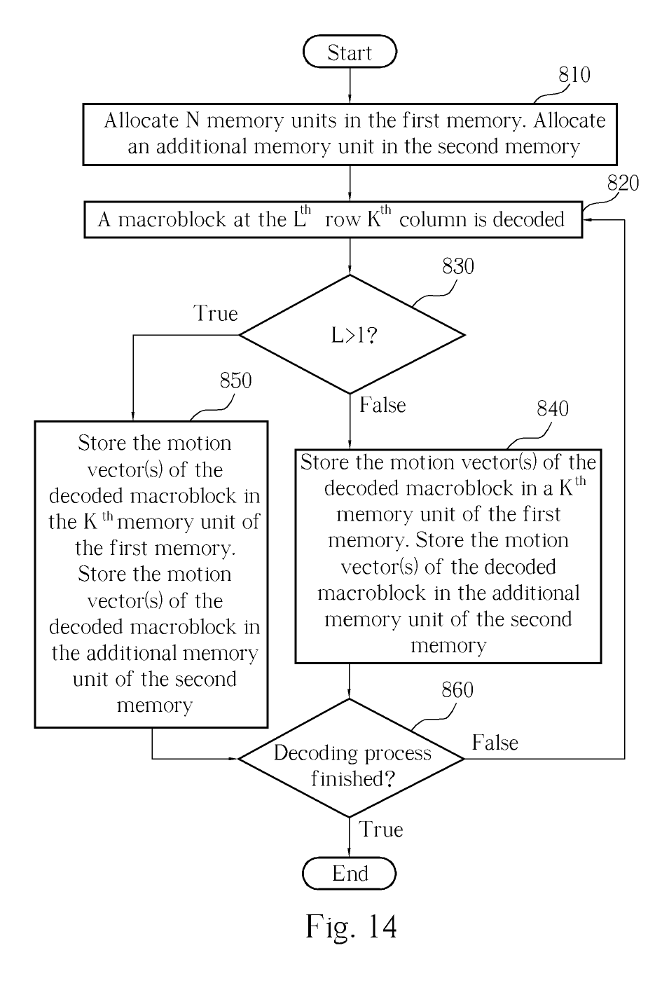

In addition to the flowcharts shown in FIG. 12 and FIG. 13, the present invention also contains the idea of memory reuse. In the prior art, when allocating memory space for storing motion vectors, each video frame is considered as a whole. However, in the present invention, the row of the macroblock rather than the entire video frame is considered as a whole. Please refer to FIG. 14 showing a flowchart according to a third embodiment of the present invention. The flowchart shown in FIG. 14 contains the following steps:
810: Allocate N memory units in a first memory, and allocate an additional memory unit in a second memory. Each one of the N memory units in the first memory and the additional memory unit in the second memory is sufficient for storing motion vector(s) of a single macroblock. More specifically, the N memory units are used to store motion vectors of a row of macroblocks, in case the stored motion vectors will be used as candidate predictors when macroblocks on a next row are going to be decoded. Hence each of the N memory unit could contain a first and a second memory space as described in FIG. 12. And the additional memory unit is used to store motion vector(s) of each decoded macroblock in case the motion vector(s) of the decoded macroblock will be used as candidate predictor(s) when a next macroblock is going to be decoded. Hence the additional memory unit could contain a third and a fourth memory space as described in FIG. 13.
820: A macroblock at the L^{th} row and K^{th} column is decoded.
830: Is L>1? If yes, go to step 850, otherwise go to step 840.
840: The decoded macroblock is located at a first row of a video frame. Store the motion vector(s) of the decoded macroblock in a K^{th} memory unit of the N memory units in the first memory, and store the motion vector(s) of the decoded macroblock in the additional memory unit in the second memory. Under the condition that each of the N memory unit contains a first and a second memory space described in FIG. 12 and the additional memory unit contains a third and a fourth memory space described in FIG. 13. If the decoded macroblock is a type-1 macroblock, its motion vectors could be stored in the first or the second memory spaces (or be stored in both of these two memory spaces), and stored in the third or the fourth memory spaces (or be stored in both of these two memory spaces). If the decoded macroblock is a type-2 macroblock, the motion vector of its second block could be stored in the third memory space, the motion vector of its third block could be stored in the first memory space, and the motion vector of its fourth block could be stored in the second and fourth memory spaces. If the decoded macroblock is a type-3 macroblock, the motion vector of its first field could be stored in the first and third memory spaces, and the motion vector of its second field could be stored in the second and fourth memory spaces. In this way, each time a macroblock is decoded, its motion vector(s) will always been stored in the additional memory unit in the second memory, overwriting the motion vector(s) of a previously decoded macroblock, so the additional memory unit in the second memory will be reused once each time a macroblock is decoded. And at this time each of the 1^{st}˜K^{th} memory units of the N memory units in the first memory is stored with the motion vector(s) of the 1^{st}˜K^{th} macroblocks of the 1st row respectively; each of the (K+1)^{th}˜N^{th} memory units of the N memory units in the first memory is empty or stored with the motion vectors of macroblocks in a previous decoded video frame (which will not be used as candidate predictors in decoding this video frame); the additional memory unit in the second memory is stored with the motion vector(s) of the (K−1)^{th} macroblocks of the 1^{st} row (when K>1), or stored with the motion vector(s) of a macroblock in the previous decoded video frame (which will not be used as candidate predictors in decoding this video frame).
850: The decoded macroblock is located at an L^{th} row of the video frame (L>1). Store the motion vector(s) of the decoded macroblock in a K^{th} memory unit of the N memory units in the first memory, and store the motion vector(s) of the decoded macroblock in the additional memory unit in the second memory. Again, under the condition that each of the N memory unit contains a first and a second memory unit described in FIG. 12 and the additional memory unit contains a third and a fourth memory space described in FIG. 13. If the decoded macroblock is a type-1 macroblock, its motion vectors could be stored in the first or the second memory spaces (or be stored in both of these two memory spaces), and stored in the third or the fourth memory spaces (or be stored in both of these two memory spaces). If the decoded macroblock is a type-2 macroblock, the motion vector of its second block could be stored in the third memory space, the motion vector of its third block could be stored in the first memory space, and the motion vector of its fourth block could be stored in the second and fourth memory spaces. If the decoded macroblock is a type-3 macroblock, the motion vector of its first field could be stored in the first and third memory spaces, and the motion vector of its second field could be stored in the second and fourth memory spaces. In this way, when L>1, the motion vector(s) of decoded macroblock at L^{th} row and K^{th} column will be stored at the memory unit originally storing the motion vector(s) of a previously decoded macroblock at the (L−1)^{th} row and K^{th} column. That is, the motion vector(s) of macroblock at (L−1)^{th} row and K^{th} column will be overwritten by the motion vector(s) of macroblock at L^{th} row and K^{th} column. In other words, the N memory units in the first memory will be reused once each time a row of macroblocks is decoded. And at this time each of the 1^{st}˜K^{th} memory units of the N memory units in the first memory is stored with the motion vector(s) of the 1^{st}˜K^{th} macroblocks of the L^{th} row respectively; each of the (K+1)^{th}˜N^{th} memory units of the N memory units in the first memory is stored with the motion vector(s) of the (K+1)^{th}˜N^{th} macroblocks of the (L−1)^{th} row respectively; the additional memory unit in the second memory is stored with the motion vector(s) of the (K−1)^{th} macroblocks of the L^{th} row (when K>1), or stored with the motion vector(s) of the N^{th} macroblocks of the (L−1)^{th} row (which will not be used as candidate predictors in decoding macroblocks at the L^{th} row).
860: If the decoding process is not finished, return to step 820.

Using the row based memory reuse scheme provided by the present invention, at each time point what the system must store are motion vectors of a row of macroblocks and a previous decoded macroblock. Taking a video frame with 720*480 pixels as an example, by using the method provided by the present invention, the system has to allocate only (720÷16) memory units (that is, (720÷16)×2 memory spaces) in the first memory and one memory unit (that is, two memory spaces) in the second memory (each allocated memory space being sufficient for storing one motion vector). Compared with the prior art, by using the method provided by the present invention, memory resources are used more efficiently.

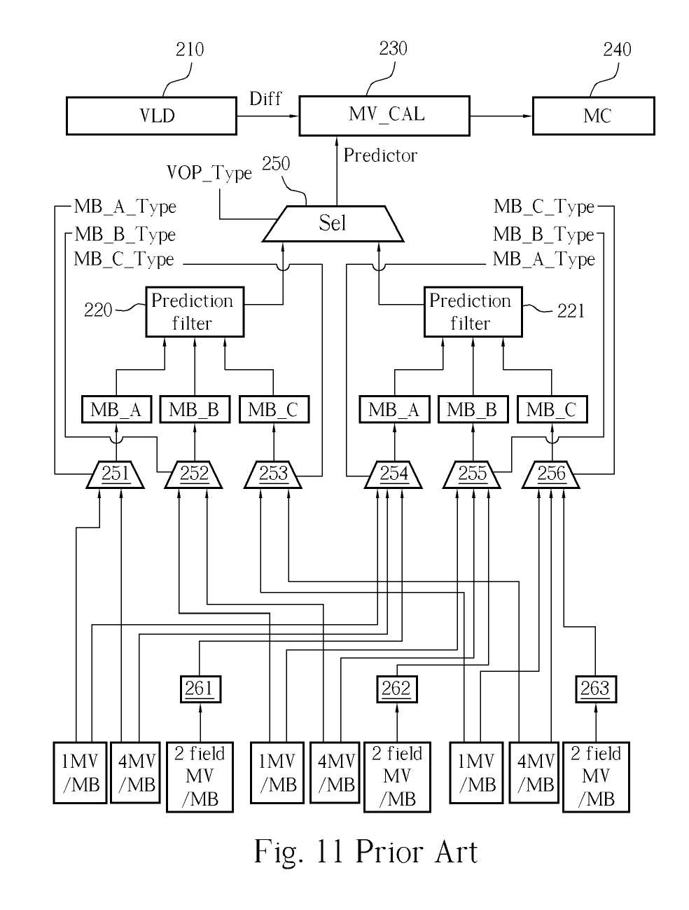

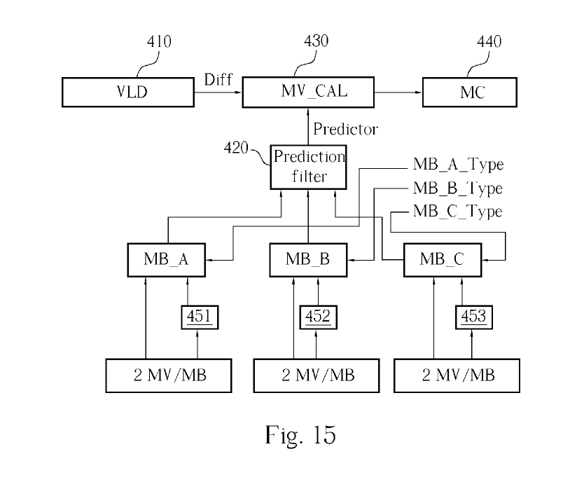

Next, please refer to FIG. 15 showing a system for processing motion compensation with a method provided by the present invention. The system configuration shown in FIG. 15 is similar to that shown in FIG. 11, a major difference is that by using the method provided by the present invention, the system only has to allocate two memory spaces for each of macroblock A, B, and C. Where each allocated memory space is sufficient for storing a motion vector. MB_A_Type, MB_B_Type, and MB_C_Type are selecting signals according to macroblocks A, B, and C's type. Taking macroblock A as an example, when macroblock A is a type-1 macroblock, each one of the two memory spaces allocated for macroblock A can provide the proper motion vector as a candidate predictor. When macroblock A is a type-2 macroblock, one of the two memory spaces allocated for macroblock A can provide the proper motion vector as a candidate predictor (depends on the motion vector of macroblock A's second or fourth block will be used as the candidate predictor). When macroblock A is a type-3 macroblock, by applying Div2Round function on the two motion vectors stored in the two memory spaces allocated for macroblock A, the filter 451 can provide the proper motion vector as candidate predictor.

Please note that the system shown in FIG. 15 can handle motion compensation for both progressive frames and interlaced frames. However, a system designer can also design a system simply for handling motion compensation for only progressive frames or only interlaced frames according to the method provided by the present invention.

In contrast to the conventional system, a system employing the present invention uses less memory space, which means the memory is used more efficiently. Hence system resources are saved.

Those skilled in the art will readily observe that numerous modifications and alterations of the device and method may be made while retaining the teachings of the invention. Accordingly, the above disclosure should be construed as limited only by the metes and bounds of the appended claims.

1. A memory management method used in the decoding process of a video frame, for storing motion vector(s) of a decoded first macroblock as candidate predictor(s) for future use in the decoding process, the method comprising:
allocating a first memory space and a second memory space in a first memory, wherein each of the first and the second memory spaces is sufficient for storing one motion vector; and
when the first macroblock comprises only one first motion vector, storing the first motion vector in the first or the second memory space.

2. The method of claim 1, further comprising:
when the first macroblock comprises a first block, a second block, a third block, and a fourth block, storing the motion vector of the third block in the first memory space and storing the motion vector of the fourth block in the second memory space.

3. The method of claim 1, wherein the video frame is a progressive frame.

4. The method of claim 1, wherein the video frame is an interlaced frame.

5. The method of claim 4, further comprising:
when the first macroblock comprises a first field and a second field, storing the motion vector of the first field in the first memory space and storing the motion vector of the second field in the second memory space.

6. The method of claim 1, wherein the first memory is a DRAM, an SRAM, or registers.

7. A memory management method used in the decoding process of a video frame, for storing the motion vector(s) of a decoded first macroblock as candidate predictor(s) for use in decoding a next macroblock, the method comprising:
allocating a third memory space and a fourth memory space in a second memory, wherein each of the third and the fourth memory spaces is sufficient for storing one motion vector; and
when the first macroblock comprises only one first motion vector, storing the first motion vector in the third or the fourth memory space.

8. The method of claim 7, further comprising:
when the first macroblock comprises a first block, a second block, a third block, and a fourth block, storing the motion vector of the third block in the third memory space and storing the motion vector of the fourth block in the fourth memory space.

9. The method of claim 7, wherein the video frame is a progressive frame.

10. The method of claim 7, wherein the video frame is an interlaced frame.

11. The method of claim 10, further comprising:
when the first macroblock comprises a first field and a second field, storing the motion vector of the first field in the third memory space and storing the motion vector of the second field in the fourth memory space.

12. The method of claim 7, wherein the first memory comprises processing registers, registers, a DRAM, or an SRAM.

13. A row-based memory management method used in the decoding process of a video frame, for storing the motion vectors of a plurality of decoded macroblocks as candidate predictors for use in the decoding process, wherein each row of the video frame comprises N macroblocks, the method comprising:
allocating N memory units in a first memory, wherein each memory unit is sufficient for storing the motion vector(s) of one macroblock;
when a first macroblock located at an L^{th} row and a K^{th} column is decoded, storing the motion vector(s) of the first macroblock in a K^{th} memory unit of the memory units to overwrite the motion vector(s) of a second macroblock previously stored in the K^{th} memory unit, wherein the second macroblock is located at an (L−1)^{th} row and the K^{th} column, K is an integer between 1 and N, and L is an integer larger than 1.

14. The method of claim 13, wherein the video frame is a progressive frame.

15. The method of claim 13, wherein the video frame is an interlaced frame.

16. The method of claim 13, wherein the first memory comprises a DRAM, an SRAM, or registers.

17. The method of claim 13, further comprising:
allocating an additional memory unit in a second memory, wherein the additional memory unit is capable of storing the motion vector(s) of one macroblock;
when a third macroblock of the video frame is decoded, storing the motion vector(s) of the third macroblock in the additional memory unit to overwrite the motion vector(s) of a fourth macroblock previously stored in the additional memory unit, wherein the fourth macroblock is decoded immediately before the third macroblock.

18. The method of claim 17, wherein the first memory comprises processing registers, registers, a DRAM, or an SRAM.
